(19) United States
(12) Patent Application Publication
(10) Pub. No.: US 2006/0185406 A1
(43) Pub. Date: Aug. 24, 2006

(54) Locking latch assembly

(75) Inventor: Roger P. Willems, High Wycombe (GB)

Correspondence Address: Robert D. Hornbaker;Freilich Hornbaker & Rosen, Suite 1220, 10960, Los Angeles, CA, 90024, US

(73) Assignee: Penn Elcom, Inc.

(21) Appl. No.: 11/061,943

(22) Filed: Feb. 19, 2005

(51) Int. Cl. E05B 13/00

(52) U.S. Cl. 70/208; 70/210

(57) ABSTRACT

A latch assembly comprising: a recessed half dish, or half cup; a bracket mounted on the bottom of said half dish, or half cup; an arm assembly, including a bolt and a key, the arm assembly being totally mounted on the bracket, the key having a raised position, for turning the key, to extend and retract the bolt, and a stowed position; means, including the bracket, for locking the key in the stowed position; a second recessed half dish, or half cup; a striker plate bracket mounted on the bottom of said half dish, or half cup; a striker plate; and spring means for mounting the striker plate on the striker plate bracket.

### BACKGROUND OF THE INVENTION

In U.S. Pat. No. 5,511,834, entitled “Automatically Positioned Latch Assembly”, patented Apr. 30, 1996, hereafter called the Patent, which is incorporated herein by reference, I show, and describe, a prior art latch 20 for securing the lid 22 and body 24 of a case 26. The Patent shows, and describes, an arm assembly 36, including a bolt 48 and key 50, having a stowed position 50B, rotatably carried at a pivot end 37 thereof by a pair of springs 38 mounted within the bracket 40. The Patent also shows, and describes, a striker plate 32. Other prior art locked the latch, by locking the bolt to the striker plate. Still other prior art locked the latch, by locking the key, in the stowed position, to the arm assembly.

### SUMMARY OF THE INVENTION

An object of the present invention is to lock the latch, by locking the key, in the stowed position, to the bracket. This object is obtained by providing an elongated opening in the bracket, and a rotatable element, in a bearing in the key, having a projection on one end that engages the elongated opening, as it is rotated, by a removable element, on the other end, with the key in the stowed position, to lock the key in that position, and thereby also lock the latch.

### BRIEF DESCRIPTION OF THE DRAWINGS

FIG. 1 is a plan view of the latch in the open position.

FIG. 2 is a plan view of the latch in the closed position, with the key in the stored position and locked.

FIG. 3 is a sectional view of FIG. 2 along the lines 3-3.

FIG. 4 is a sectional view of FIG. 2 along the lines 4-4.

FIG. 5 is a sectional view of FIG. 4 along the lines 5-5.

### DESCRIPTION OF THE PREFERRED EMBODIMENT

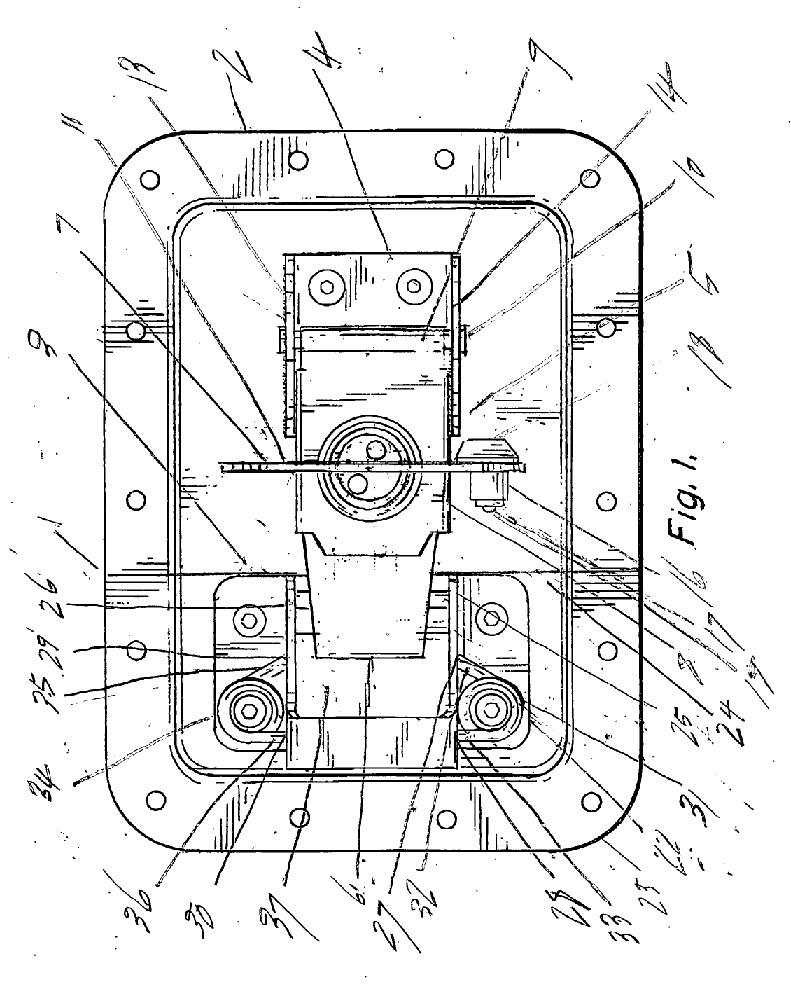

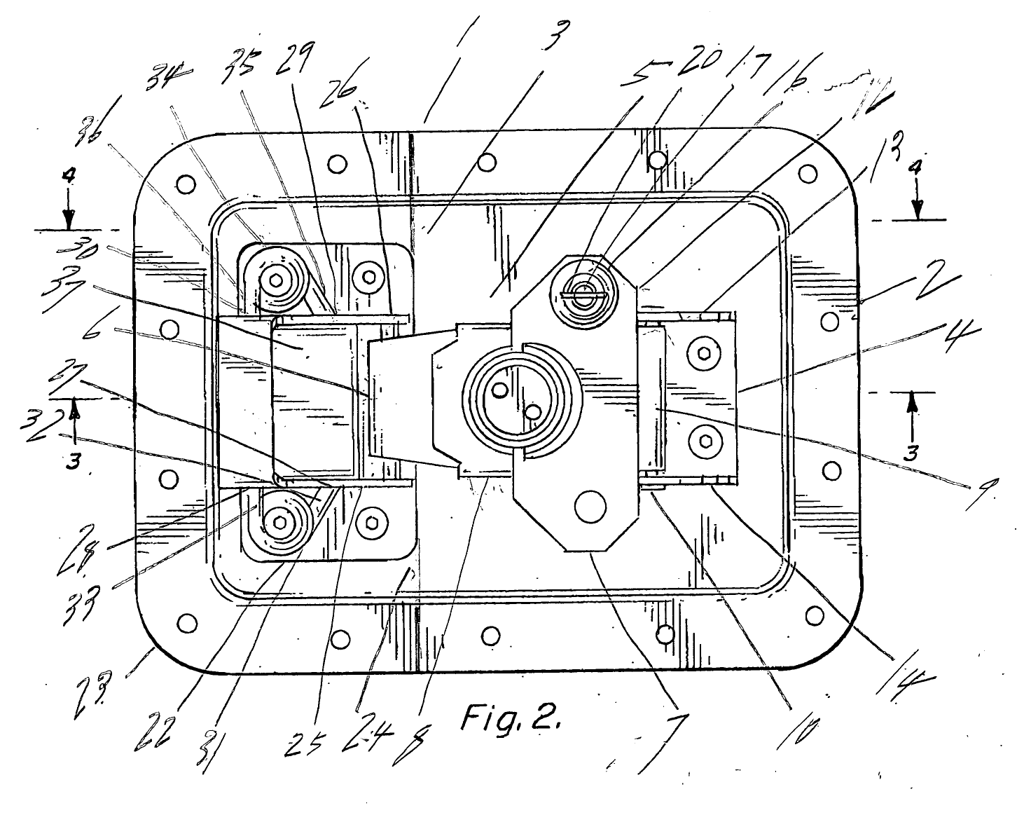

Referring to FIGS. 1 and 2, I show a latch assembly 1 comprising a recessed half dish, or half cup 2, having an open side, or part 3, and a bracket 4 mounted on the bottom of the half dish, or half cup 2. An arm assembly 5, including a bolt 6, key 7, housing 8 and tube 9, is rotatably mounted on the bracket 4 by a pin 10. The structure, and operation, of the arm assembly 5 is otherwise shown and described in the Patent. As used herein, the term “half dish” or “half cup” is not limited to its literal meaning, and includes anything having a recess with an open side, or part, that permits the engagement of a bolt with a striker plate. Also, the term “half dish” or “half cup” includes more, or less, than one-half of a dish or cup, as long as two of the half dishes or half cups form one dish or cup, when the open sides, or parts, are adjacent each other.

The key 7 has a raised position 11, shown in FIG. 1, for turning the key 7 by hand, to extend and retract the bolt 6, and a stowed position 12, shown in FIG. 2. As described in the Patent, turning the key 7, in its raised position 11, extends and retracts the bolt 6. The bracket 4 has a pair of sides 13, 14, and one of the sides 13 has an elongated opening 15 therein. The key 7 has a bearing 16 therein, and a rotatable member 17, in the bearing 16, has a pair of ends 18, 19. One end 18 receives a removable element 20 for turning the rotatable member 17. The other end 19 extends outside the bearing 16 and has a projection 21 thereon that engages the elongated opening 15, as the rotatable member 17 is turned, with the key 7 in the stowed position 12, to lock the key 7 in that position, and thereby also lock the latch.

Referring to FIGS. 1-3, a striker plate bracket 22 is mounted in the bottom of the recessed half dish, or half cup 23, which has an open side, or part 24. The striker plate bracket 22 has a pair of sides 25, 26, the first side 25 having a hole 27 and a slot 28 therein, and the second side 26 having a hole 29 and a slot 30 therein. A first coil spring 31 has a pair of ends 32, 33, one end 32 extending through the hole 27 in first side 25, and the other end 33 extending through the slot 28 in the first side 25. A second coil spring 34 has a pair of ends 35, 36, one end 35 extending through the hole 29 in the second side 26, and the other end 36 extending through the slot 30 in the second side 26. A striker plate 37 is mounted between the sides 25, 26 of the striker plate bracket 22, on the ends 33, 36 of the coil springs 31, 34 extending through the slots 28, 30, to bias the striker plate 37 away from the open side, or part 24 of the recessed half dish or half cup 23. So the striker plate 37 is resiliently mounted in the striker plate bracket 22 on springs 31, 34, in the same way that the arm assembly 36 in the Patent is mounted within bracket 40 on the ends of a pair of springs 38.

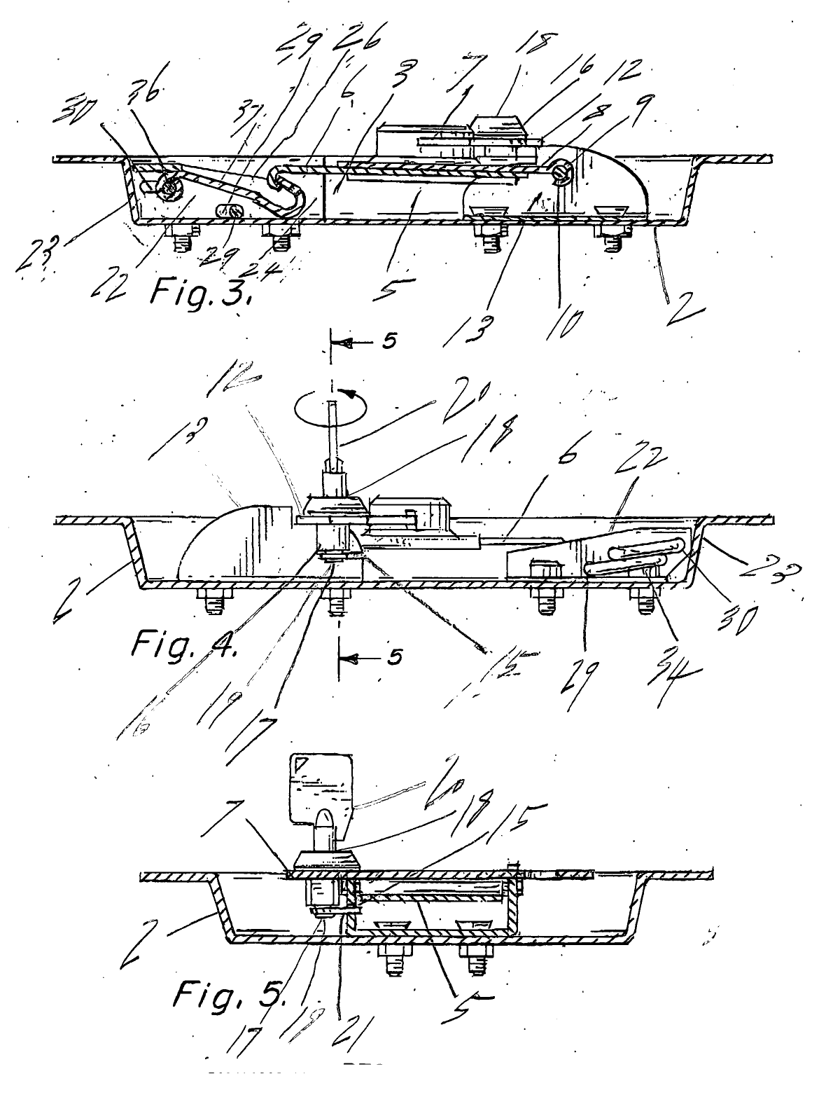

FIG. 1 shows the latch assembly 1 in the open position, in which the bolt 6 is not engaging the striker plate 37. FIG. 2 shows the latch assembly 1 in the closed position, in which the bolt 6 engages the striker plate 37, through the open sides, or parts 3, 24, with the striker plate 37 biased away from the bolt 6 and the open sides, or parts 3, 24, by the springs 31, 34, as best shown in FIG. 3. FIGS. 4 and 5 show the elongated opening 15, bearing 16, rotatable member 17, its ends 18, 19, removable element 20 and projection 21, in the locked position. As shown in FIG. 4, the rotatable member 17, removable element 20, and projection 21 are rotated counter-clockwise to engage the elongated opening 15.

In another embodiment, the bolt 6, could be biased away from the striker plate 37, by mounting the arm assembly 5 on the ends of springs, extending through holes, and slots, in the sides 13, 14 of bracket 4, as shown in the Patent. In this embodiment, the striker plate 37 could be mounted on the bottom of the half dish, or half cup 23, as also shown in the Patent. In the preferred embodiment, however, the key 7 is locked to the bracket 4, without changing the standard sizes of the half dishes, or half cups, because mounting the arm assembly 5 on the pin 10, instead of the ends of springs, as shown in the Patent, leaves room for the elongated opening 15 in the bracket 4.

The preferred embodiment of the invention described herein is exemplary and numerous modifications, dimensional variations and rearrangements can be readily envisioned to achieve an equivalent result, all of which are intended to be embraced within the scope of the appended claims.

1. A latch assembly comprising:
a recessed half dish, or half cup, having an open side, or part;
a bracket mounted on the bottom of the said half dish, or half cup;
an arm assembly, including a bolt, extending through the open side, or part, and a key, said arm assembly being rotatably mounted on the bracket, the key having a raised position, for turning the key by hand, to extend and retract the bolt, and a stowed position;
means, including the bracket, for locking the key in the stowed position.

2. A latch assembly comprising:
a recessed half dish, or half cup, having an open side, or part;
a bracket mounted on the bottom of said half dish, or half cup, the bracket having a pair of sides, one of the sides having an elongated opening therein;
an arm assembly, including a bolt, extending through the open side, or part, and a key, said arm assembly being rotatably mounted on the bracket, between the sides thereof, the key having a raised position, for turning the key by hand, to extend and retract the bolt, and a stowed position;
a bearing in the key;
a rotatable member, in the bearing, said member having a pair of ends, one end being adapted to receive a removable element, for turning said member, and the other end extending outside the bearing and having a projection thereon that engages the elongated opening, as said member is turned, with the key in the stowed position, to lock the key in that position; and
a removable element for turning the rotatable member.

3. A latch assembly comprising:
a recessed half dish, or half cup, having an open side, or part;
a striker plate bracket mounted on the bottom of said half dish, or half cup;
a striker plate;
spring means for mounting the striker plate on the striker plate bracket, to bias the striker plate away from the open side, or part.

4. A latch assembly comprising:
a recessed half dish, or half cup, having an open side, or part;
a striker plate bracket mounted on the bottom of said half dish, or half cup, said bracket having a pair of sides, the first side having a hole and a slot therein, and the second side having a hole and a slot therein;
a first spring having a pair of ends, one end extending through the hole in the first side and the other end extending through the slot in the first side;
a second spring having a pair of ends, one end extending through the hole in the second side and the other end extending through the slot in the second side;
a striker plate, mounted between the sides, on the ends of the springs, extending through the slots, to bias the striker plate away from the open side, or part.

5. A latch assembly comprising:
a first recessed half dish, or half cup, having an open side or part;
a bracket mounted on the bottom of the said half dish, or half cup;
an arm assembly, including a bolt, extending through the open side, or part, and a key, said arm assembly being rotatably mounted on the bracket, the key having a raised position, for turning the key by hand, to extend and retract the bolt, and a stowed position;
means, including the bracket, for locking the key in the stowed position;
a second recessed half dish, or half cup, having an open side, or part;
a striker plate bracket mounted on the bottom of said half dish, or half cup;
a striker plate; and
spring means for mounting the striker plate on the striker plate bracket, to bias the striker plate away from the open side, or part.

6. A latch assembly comprising:
a first recessed half dish, or half cup, having an open side, or part;
a bracket mounted on the bottom of the said half dish, or half cup;
an arm assembly, including a bolt, extending through the open side, or part, and a key, said arm assembly being rotatably mounted on the bracket, the key having a raised position, for turning the key by hand, to extend and retract the bolt, and a stowed position;
means, including the bracket, for locking the key in the stowed position;
a second recessed half dish, or half cup, having an open side, or part;
a striker plate bracket mounted on the bottom of the said half dish, or half cup, said bracket having a pair of sides, the first side having a hole and a slot therein, and the second side having a hole and a slot therein;
a first spring having a pair of ends, one end extending through the hole in the first side and the other end extending through the slot in the first side;
a second spring having a pair of ends, one end extending through the hole in the second side and the other end extending through the slot in the second side;
a striker plate, mounted between the sides, on the ends of the springs extending through the slots, to bias the striker plate away from the open side, or part.

7. A latch assembly comprising:
a first recessed half dish, or half cup, having an open side, or part;
a bracket mounted on the bottom of said half dish, or half cup, the bracket having a pair of sides, one of the sides having an elongated opening therein;
an arm assembly, including a bolt, extending through the open side, or part, and a key, said arm assembly being rotatably mounted on the bracket, between the sides thereof, the key having a raised position, for turning the key by hand, to extend and retract the bolt, and a stowed position;
a bearing in the key;
a rotatable member, in the bearing, said member having a pair of ends, one end being adapted to receive a removable element, for turning said member, and the other end extending outside the bearing and having a projection thereon that engages the elongated opening, as said member is turned, with the key in the stowed position, to lock the key in that position; and
a removable element for turning the rotatable member;
a second recessed half dish, or half cup having an open side, or part;
a striker plate bracket mounted on the bottom of said half dish, or half cup;
a striker plate;
spring means for mounting the striker plate on the striker plate bracket, to bias the strike plate away from the open side, or part.

8. A latch assembly comprising:
a first recessed half dish, or half cup, having an open side, or part;
a bracket mounted on the bottom of said half dish, or half cup, the bracket having a pair of sides, one of the sides having an elongated opening therein;
an arm assembly, including a bolt, extending through the open side, or part, and a key, said arm assembly being rotatably mounted on the bracket, between the sides thereof, the key having a raised position, for turning the key by hand, to extend and retract the bolt, and a stowed position;
a bearing in the key;
a rotatable member, in the bearing, said member having a pair of ends, one end being adapted to receive a removable element, for turning said member, and the other end extending outside the bearing and having a projection thereon that engages the elongated opening, as said member is turned, with the key in the stowed position, to lock the key in that position; and
a removable element for turning the rotatable member;
a second recessed half dish, or half cup, having an open side, or part;
a striker plate bracket mounted on the bottom of the said half dish, or half cup, said bracket having a pair of sides, the first side a hole and a slot therein, and the second side having a hole and a slot therein;
a first spring having a pair of ends, one end extending through the hole in the first side and the other end extending through the slot in the first side;
a second spring having a pair of ends, one end extending through the hole in the second side and the other end extending through the slot in the second side;
a striker plate, mounted between the sides, on the ends of the springs extending through the slots, to bias the striker plate away from the open side, or part.

9. A latch assembly comprising:
a first recessed half dish, or half cup, having an open side, or part;
a bracket mounted on the bottom of said half dish, or half cup;
an arm assembly, including a bolt, extending through the open side, or part, and a key, the key having a raised position, for turning the key by hand, to extend and retract the bolt, and a stowed position;
spring means for rotatably mounting the arm assembly on the bracket, to bias it away from the open side, or part;
means, including the bracket, for locking the key in the stowed position.

10. A latch assembly comprising:
a first recessed half dish, or half cup, having an open side, or part;
a bracket mounted on the bottom of said half dish, or half cup;
an arm assembly, including a bolt, extending through the open side, or part, and a key, the key having a raised position, for turning the key by hand, to extend and retract the bolt, and a stowed position;
spring means for rotatably mounting the arm assembly on the bracket, to bias it away from the open side, or part;
means, including the bracket, for locking the key in the stowed position;
a second recessed half dish, or half cup, having an open side, or part; and
a striker plate mounted on the bottom of the said half dish, or half cup.

11. A latch assembly comprising:
a first recessed half dish, or half cup, having an open side, or part;
a bracket mounted on the bottom of said half dish, or half cup, the bracket having a pair of sides, the first side having a hole and a slot therein, the second side having a hole and a slot therein, and one of the sides also having an elongated opening therein;
a first spring having a pair of ends, one end extending through the hole in the first side and the other end extending through the slot in the first side;
a second spring having a pair of ends, one end extending through the hole in the second side and the other end extending through the slot in the second side;
an arm assembly, including a bolt, extending through the open side, or part, and a key, the key having a raised position, for turning the key by hand, to extend and retract the bolt, and a stowed position, the arm assembly being rotatably mounted on the ends of the springs extending through the slots; and
means, including the key, and the elongated opening, for locking the key in the stowed position.

12. A latch assembly comprising:
a recessed half dish, or half cup having an open side, or part;
a bracket mounted on the bottom of said half dish, or half cup, the bracket having a pair of sides, the first side having a hole and a slot therein, the second side having a hole and a slot therein, and one of the sides also having an elongated opening therein;
a first spring having a pair of ends, one end extending through the hole in the first side and the other end extending through the slot in the first side;
a second spring having a pair of ends, one end extending through the hole in the second side and the other end extending through the slot in the second side;
an arm assembly, including a bolt, extending through the open side, or part, and a key, the key having a raised position, for turning the key by hand, to extend and retract the bolt, and a stowed position, the arm assembly being rotatably mounted on the ends of the springs extending through the slots; and
means, including the key, and the elongated opening, for locking the key in the stowed position;
a second recessed half dish, or half cup, having an open side, or part, and
a striker plate mounted on the bottom of said half dish, or half cup.

13. A latch assembly comprising:
a recessed half dish, or half cup, having an open side, or part;
a bracket mounted on the bottom of said half dish, or half cup, said bracket having a pair of sides, one of the sides having an elongated opening therein;
an arm assembly, including a bolt, extending through the open side, or part, and a key, the key having a raised position for turning the key by hand, to extend and retract the bolt, and a stowed position;
spring means for mounting the arm assembly on the bracket;
a bearing in the key;
a rotatable member, in the bearing, said member having a pair of ends, one end being adapted to receive a removable element for turning said member, and the other end extending outside the bearing and having a projection thereon that engages the elongated opening, as said member is turned, with the key in the stowed position, to lock the key in that position; and
a removable element for turning the rotatable member.

14. A latch assembly comprising:
a first recessed half dish, or half cup, having an open side, or part;
a bracket mounted on the bottom of said half dish, or half cup, said bracket having a pair of sides, one of the sides having an elongated opening therein;
an arm assembly, including a bolt, extending through the open side, or part, and a key, the key having a raised position for turning the key by hand, to extend and retract the bolt, and a stowed position;
spring means for mounting the arm assembly on the bracket;
a bearing in the key;
a rotatable member, in the bearing, said member having a pair of ends, one end being adapted to receive a removable element for turning said member, and the other end extending outside the bearing and having a projection thereon that engages the elongated opening, as said member is turned, with the key in the stowed position, to lock the key in that position; and
a removable element for turning the rotatable member;
a second recessed half dish, or half cup, having an open side, or part; and
a striker plate mounted on the bottom of said half dish, or half cup.

15. A latch assembly comprising:
a recessed half dish, or half cup, having an open side, or part;
a bracket mounted on the bottom of said half dish, or half cup, the bracket having a pair of sides, the first side having a hole and a slot therein, the second side having a hole and a slot therein; and one of the sides also having an elongated opening therein;
a first spring having a pair of ends, one end extending through the hole in the first side and the other end extending through the slot in the first side;
a second spring having a pair of ends, one end extending through the hole in the second side and the other end extending through the slot in the second side;
an arm assembly, including a bolt, extending through the open side, or part, and a key, the key having a raised position, for turning the key by hand, to extend and retract the bolt, and a stowed position, the arm assembly being rotatably mounted on the ends of the springs extending through the slots;
a bearing in the key;
a rotatable member, in the bearing, said member having a pair of ends, one end being adapted to receive a removable element for turning said member, and the other end extending outside the bearing and having a projection thereon that engages the elongated opening, as said member is turned, with the key in the stowed position, to lock the key in that position; and
a removable element for turning the rotatable member.

16. A latch assembly comprising:
a first recessed half dish, or half cup, having an open side, or part;
a bracket mounted on the bottom of said half dish, or half cup, the bracket having a pair of sides, the first side having a hole and a slot therein, the second side having a hole and a slot therein; and one of the sides also having an elongated opening therein;
a first spring having a pair of ends, one end extending through the hole in the first side and the other end extending through the slot in the first side;
a second spring having a pair of ends, one end extending through the hole in the second side and the other end extending through the slot in the second side;
an arm assembly, including a bolt, extending through the open side, or part, and a key, the key having a raised position, for turning the key by hand, to extend and retract the bolt, and a stowed position; the arm assembly being rotatably mounted on the ends of the springs extending through the slots;
a bearing in the key;
a rotatable member, in the bearing, said member having a pair of ends, one end being adapted to receive a removable element for turning said member, and the other end extending outside the bearing and having a projection thereon that engages the elongated opening, as said member is turned, with the key in the stowed position, to lock the key in that position; and
a removable element for turning the rotatable member;
a second recessed half dish, or half cup, having an open side, or part; and
a striker plate mounted on the bottom of said half dish, or half cup.
